(19) United States
(12) Patent Application Publication
(10) Pub. No.: US 2007/0155550 A1
(43) Pub. Date: Jul. 5, 2007

(54) Belt-driven conical-pulley transmission and vehicle with such a transmission

(75) Inventor: Hartmut Faust, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/634,797

(22) Filed: Dec. 6, 2006

Related U.S. Application Data
(60) Provisional application No. 60/748,054, filed on Dec. 7, 2005.

(51) Int. Cl. F16H 55/56; F16H 63/00

(52) U.S. Cl. 474/8; 474/18

(57) ABSTRACT

A conical disk pair of a belt-driven conical-pulley transmission includes an axially fixed disk and an axially movable disk, which each are positioned on respective shafts on the input side and the take-off side of the transmission. The disk pairs are connectable by an endless torque-transmitting member for transmitting torque. At least one of the shafts has at least one axial bore extending in the longitudinal direction of the shaft, from which at least one connecting bore extends to the outer surface of the shaft. The outlet of the connecting bore is situated at the shaft outer surface in a region that the movable disk overlies. An annulus is formed between the shaft outer surface and a radially inner surface of the movable disk, which annulus can be subjected to hydraulic pressure through the connecting bore, includes a discharge device for bleeding air bubbles from the annulus.

### BACKGROUND OF THE INVENTION

1. Field of the Invention

The present invention relates to a belt-driven conical-pulley transmission and to a vehicle equipped therewith.

2. Description of the Related Art

Belt-driven conical-pulley transmissions are enjoying growing popularity, not only due to great convenience that is possible through the continuously variable, automatically occurring change of transmission ratio, but also because of the reduction of fuel consumption that is possible in comparison to manually shifted transmissions or other automatic transmissions, especially in passenger cars.

Such continuously variable automatic transmissions have, for example, a start-up unit, a reversing planetary gearbox as the forward/reverse drive unit, a hydraulic pump, a variable speed drive, an intermediate shaft, and a differential. The variable speed drive includes two pairs of conical disks and an endless torque-transmitting means. Each conical disk pair includes a first, axially fixed conical disk and a second conical disk that is movable in the axial direction. The endless torque-transmitting means runs between the conical disk pairs, and can be, for example, a thrust belt, a pulling chain, or a band. The adjustment of the second conical disk axially relative to the first conical disk changes the running radius of the endless torque-transmitting means, and thereby the transmission ratio of the continuously variable automatic transmission.

Continuously variable automatic transmissions require a high level of pressure in order to be able to move the conical disks of the variable speed drive with the desired speed at all operating points, and also to transmit the torque with sufficient basic pressure with minimum wear.

An object of the invention is to provide a belt-driven conical-pulley transmission that has high structural durability, is economical to produce, and has a long operating life.

### SUMMARY OF THE INVENTION

In accordance with one aspect of the present invention, a belt-driven conical-pulley transmission includes a conical disk pair on the input side and a conical disk pair on the power take-off side. Each conical disk pair includes an axially fixed disk and an axially movable disk, which in each case are positioned on respective shafts on the input side and the take-off side. The conical disk pairs are connectable by an endless torque-transmitting means for transmitting torque. At least one of the shafts has at least one axial bore extending in the longitudinal direction of the shaft, from which at least one connecting bore extends to the surface of the shaft. The outlet of the connecting bore is situated on the outer surface of the shaft in a region that is covered by the movable disk independent of the latter's axial position. An annulus is formed between the outer surface of the shaft and a radially inner surface of the movable disk, which can be subjected to hydraulic pressure through the connecting bore, with a discharge device for bleeding air bubbles from the annulus.

The connecting bore opening into the outer surface of the shaft enables an axially short configuration of the axial bore, which is cost-effective and enables an axial size reduction. The discharge device helps air bubbles that are present in the annulus to escape, so that the formation of galling on a sliding seat of the movable disk can be reduced or entirely prevented.

Advantageously, the movable disk is non-rotatably connected to the shaft but is axially movable over teeth, and the teeth are located in the region of the annulus.

In addition, the belt-driven conical-pulley transmission is preferably constructed in such a way that the outlet of the connecting bore at the shaft outer surface is situated in the region of the teeth, and the discharge device is formed by an axial groove that extends from the connecting bore outlet and whose bottom is recessed in relation to the outer surface of the shaft.

Preferably, the teeth are absent in the region of the axial groove and the outlet of the connecting bore.

The discharge device can be formed by a discharge bore that extends from the annulus at an axial distance from the outlet of the connecting bore, and which opens into the axial bore.

An axial groove can extend from the outlet of the discharge bore, with its bottom sunk into the outer surface of the shaft.

In an advantageous embodiment of the belt-driven conical-pulley transmission in accordance with the invention, the annulus is sealed off on one side by a seal positioned between the shaft and an axial flange of the movable disk, and the discharge device is situated in the annulus between the seal and the outlet of the connecting bore.

In addition, a connecting channel that leads through the movable disk advantageously extends from the annulus, on its side facing away from the seal in reference to the connecting bore, into a pressure chamber, to apply hydraulic pressure to the movable disk.

### BRIEF DESCRIPTION OF THE DRAWINGS

The structure, operation, and advantages of the present invention will become further apparent upon consideration of the following description, taken in conjunction with the accompanying drawings in which:

FIG. 1 is a cross-sectional view of a part of a belt-driven conical-pulley transmission in accordance with the invention;

FIGS. 2 and 3 are enlarged cross-sectional views of portions of FIG. 1;

FIG. 4 is a cross-sectional view taken along the line IV-IV of FIG. 1; and

FIG. 5 is an enlarged cross-sectional view similar to FIG. 2 showing a modified embodiment of the invention.

### DESCRIPTION OF THE PREFERRED EMBODIMENTS

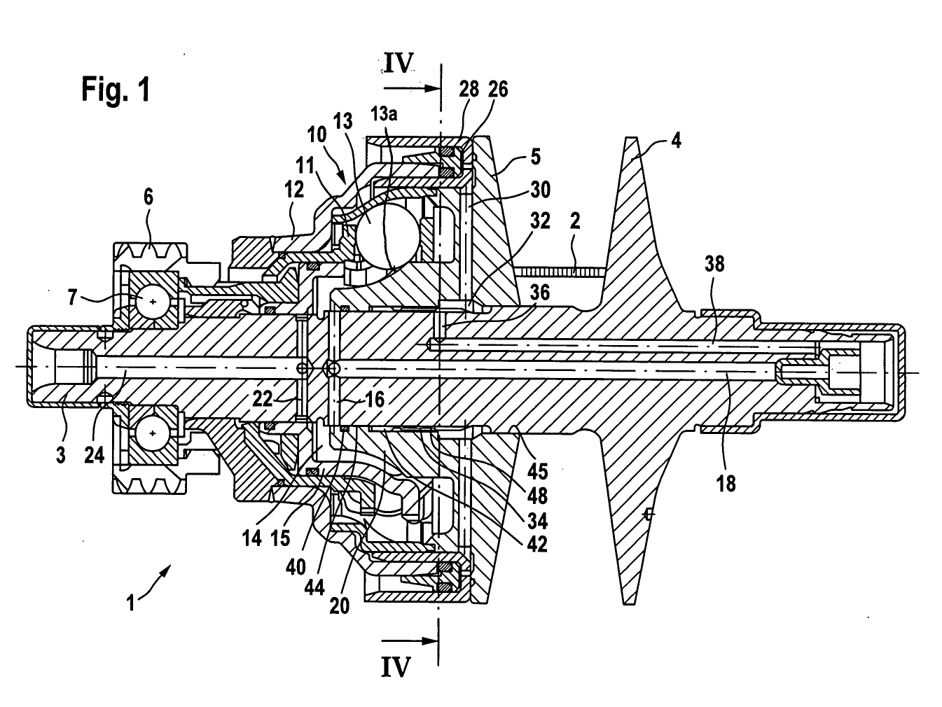

FIG. 1 shows part of a belt-driven conical-pulley transmission, namely the input or driven side of the belt-driven conical-pulley transmission designated in its entirety as 1, which is driven by a drive motor (not shown), for example an internal combustion engine. In a fully implemented belt-driven conical-pulley transmission, associated with that input-side part there is a complementarily designed take-off side part of the continuously variable belt-driven conical-pulley transmission, the two parts being connected by an endless torque-transmitting means in the form of a plate-link chain 2, for example, for transmitting torque. Belt-driven conical-pulley transmission part 1 has a shaft 3 on its input side, which is designed in the illustrated exemplary embodiment as a single piece with a stationary conical disk, or fixed disk, 4. The axially fixed conical disk 4 is positioned in the axial longitudinal direction of shaft 3 close to and opposite from an axially displaceable conical disk, or movable disk, 5.

The torque provided by a drive engine is introduced into the input side part of the belt-driven conical-pulley transmission shown in FIG. 1 by way of a gear 6 mounted on shaft 3, which is supported on shaft 3 by means of a roller bearing in the form of a ball bearing 7 that absorbs axial and radial forces, which is axially fixed on shaft 3. Between gear 6 and axially movable conical disk 5 is a torque sensor 10 which has an axially fixed spreader disk 11 that is supported on an also axially fixed support ring 12, and interacts with a spreading surface 14 formed directly on the movable disk 5 through rolling elements in the form of balls 13.

In the condition shown in FIG. 1, movable disk 5 is at its most distant position from the fixed disk, i.e., the transmission is in underdrive.

A torque introduced through gear 6 results in a relative rotation between axially fixed spreader disk 11 and axially movable spreading surface 13a of movable disk 5, which results in an axial movement to the right in accordance with the figure, due to sloping ramps on which the balls 13 run up.

Torque sensor 10 also has a pressure chamber 14, which is bounded by shaft 3, movable disk 5, and a sensor piston 15. Sensor piston 15 follows the axial motion of the balls 13. Its position thus depends on the torque. An inlet bore 16 that is chargeable with hydraulic fluid through a central axial bore 18 in shaft 3 opens into pressure chamber 14. In the underdrive position of the disk pair as shown, the outlet of inlet bore 16 is substantially closed by the left edge of a collar 20 of movable disk 5. Also opening into pressure chamber 14 is an outlet bore 22, which leads into an axial discharge channel 24 of shaft 3. The effective cross section of outlet bore 22 is influenced by the position of sensor piston 15. Overall, with the described arrangement the force exerted on the movable disk can be changed in a known way, depending upon the torque and the transmission ratio.

Movable disk 5 is repositioned by an additional pressure chamber 26, which is formed between support ring 12 and an annular piston 28 attached to movable disk 5 and is supplied with hydraulic fluid via connecting channels 30 that lead through movable disk 5 from an annulus 32. Annulus 32 is formed between a recess in the inner surface of movable disk 5, or its collar 20, and the outer surface of shaft 3. Within annulus 32 are the axial teeth 34 through which movable disk 5 is engaged with shaft 3 in a rotationally fixed but axially movable manner. Into annulus 32 issues a connecting bore 36 formed in shaft 3, through which annulus 32 and thus pressure chamber 26 can be subjected to control pressure which can be delivered to an axial bore 38 in shaft 3 in the form of a blind bore. The control pressure applied to axial bore 38 to adjust the transmission ratio is controlled in a known manner by a control device, which subjects movable disk 5 to an adjusting pressure that depends on the operating conditions of the motor vehicle, in addition to the pressure present in the pressure chamber 14, which depends upon the torque.

The transmission described above can be built compactly and is of known construction.

Because of their differing functions, pressure chambers 14 and 26, which must be charged with different pressures in many operating ranges, must be clearly separated from each other hydraulically. That is accomplished by means of a seal in the form of a sealing ring 40, for example, which seals between the left end region in accordance with FIG. 1 of the collar 20 fixed on the movable disk and the outer surface of shaft 3.

As can be seen directly from FIG. 1, to the left side of the axial teeth there is a blind space region 42 of annulus 32 from which no hydraulic fluid can flow, because of sealing ring 40. Guide surfaces 44 formed on the inner surface of collar 20 and on the outer surface of shaft 3, which guide movable disk 5 axially and absorb the high tilting forces caused by the pressure of the plate-link chain on movable disk 5, are as a result not lubricated by constantly replenished hydraulic fluid, so that heavy demands are placed on its condition in order to prevent fretting corrosion. Such fretting corrosion can occur in particular if there are permanent gas bubbles present in the adjacent blind space region 42, for example, that support the corrosion.

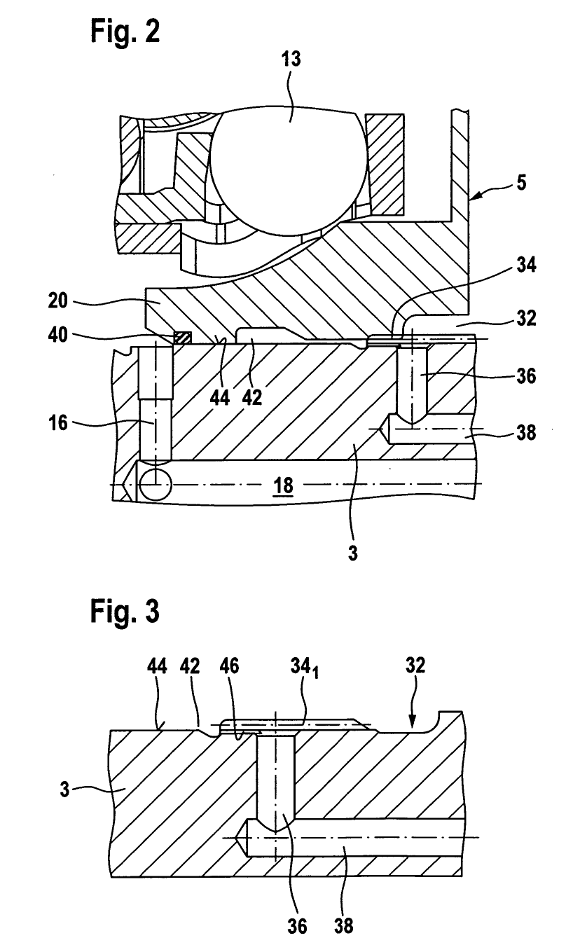

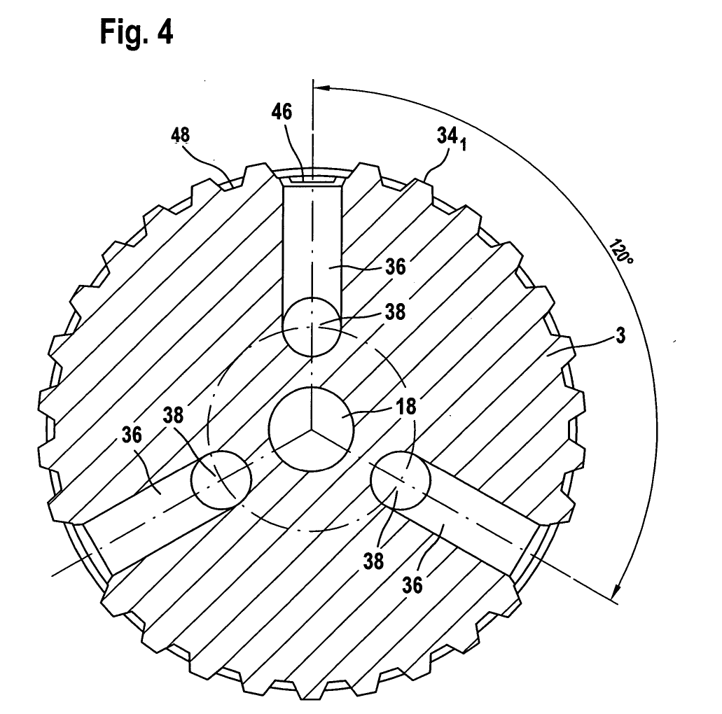

It is therefore advisable to provide annulus 32 with a discharge arrangement for discharging air or gas bubbles. An example of such a discharge arrangement will be explained below on the basis of FIGS. 2 through 4, wherein FIG. 2 shows an enlarged detail of a portion of FIG. 1, FIG. 3 shows a part only of the shaft visible in FIG. 2, and FIG. 4 shows a section through the shaft at the plane IV-IV (FIG. 1).

In accordance with the drawings, connecting bore 36 issues into annulus 32 in the region of the axial teeth 34. That has the advantage not only of enabling better lubrication of the teeth, but also has mechanical advantages over an outlet of connecting bore 36 in the region of a recess that is to the right of teeth 34 in the figures.

As can be seen in particular in FIGS. 3 and 4, an axial groove 46 on the outer surface of shaft 3 extends from the outlet of connecting bore 36 into the blind space region 42 of annulus 32. Axial groove 46 is recessed into the bottom land between the axial teeth 34₁ of shaft 3, so that the bottom of axial groove 46 is lower than the adjacent outer surface 44 of shaft 3, which forms one of the guide surfaces in the longitudinal extension of shaft 3 as shown in the drawings. Because the bottom of axial groove 46 is situated deeper than shaft outer surface 44, any gas bubbles that can be in the blind space region 42 move to the location in the annulus with the smallest diameter when the shaft turns, because of their lower specific weight relative to that of the hydraulic fluid, due to the “negative” force.” That is, the bubbles move from blind space region 42 to and along axial groove 46, and from there through connecting bore 36 and axial bore 38 and, in any case, out of the arrangement, by escaping into blind hole 38 at leakage sites in the rotating supply line for hydraulic fluid.

Guide surfaces 45 (see FIG. 1) are also formed to the right side of teeth 34 to guide movable disk 5 along shaft 3. But there is little or no danger of fretting corrosion there, since the contacting guide surfaces are not sealed against each other, and a small amount of hydraulic fluid can escape into the space between the two conical disks. But under some circumstances it can be appropriate to also form on the right side of the outlet of connecting bore 36 an axial groove similar to the axial groove 46 shown in the drawings.

FIG. 4 shows a cross-sectional view of the structural arrangement. Clearly visible is axial groove 46, which is recessed below the bottom land between axial teeth 34, and whose level is identified as 48. It is also clearly visible in FIG. 4 that a tooth of the axial teeth 34₁ of shaft 3 is missing in the region of connecting bore 36. In accordance with FIG. 4, there are within shaft 3 three axial bores 38 with associated connecting bores 36, with the axial teeth absent at each outlet. It should be understood that the axial teeth do not have to be eliminated over the entire axial length of axial teeth 34₁, but are absent only in the tooth region that would otherwise overlie the outlets of connecting bores 36, or are absent only in the region along which axial groove 46 extends. In addition, as shown in FIG. 4 axial grooves 46 can be provided at the outlets of all three connecting bores 36.

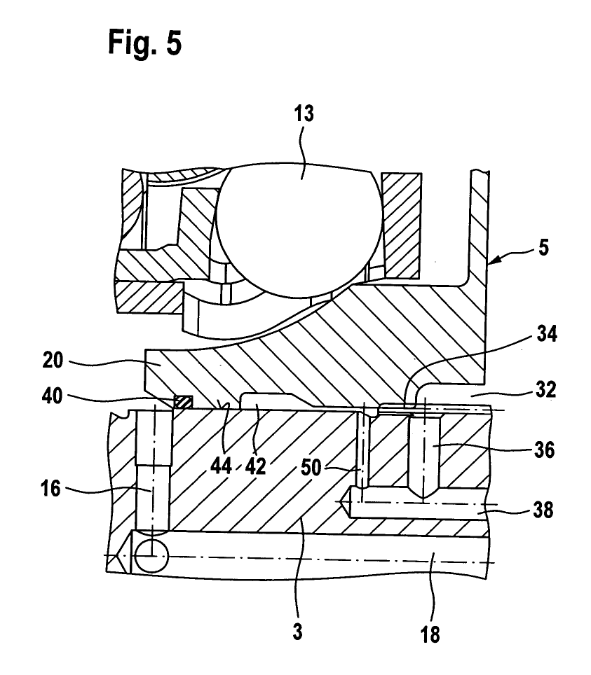

FIG. 5 shows an enlarged cross-sectional view, similar to FIG. 2, of a modified embodiment. In that embodiment there is a discharge bore 50 separate from connecting bore 36, which extends inwardly to axial bore 38 from the bottom of blind space region 42, or, advantageously, inwardly from an axial groove formed in the outer surface of shaft 3. It should be understood that the discharge bore 50 advantageously extends from at least a part of the blind space region 42 that is not covered by seal 40 when the movable disk moves to its position of furthest displacement to the right as viewed in FIG. 1.

The described measures for removing gas bubbles from annulus 32, in particular from its blind space region 42, can be employed individually or in combination. The number of axial grooves or discharge bores distributed around the circumference of shaft 3 is determined by the particular requirements. The radial dimension from the bottom of axial groove 46 to the outer surface of shaft 3 is approximately 0.2 mm. It is also advantageous if, as shown, the toothed region of the shaft 3 extends over a small indentation in the otherwise constant radius of the shaft outer surface that forms a guide surface. It is also advantageous if the bottom of axial groove 46 is inclined toward the outlet of the respective connecting bore 36 that leads into the axial bore 38 of the shaft, for example by having the depth of the axial groove increase in a direction toward the connecting bore. Connecting bores 36 and discharge bores 50 do not have to extend radially, but can extend inclined to the radial direction.

The invention can advantageously be employed wherever an annular dead-end chamber that bounds on seating or guide surfaces is formed around a shaft of a belt-driven conical-pulley transmission.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A belt-driven conical-pulley transmission, said transmission comprising:
conical disk pairs on each of an input side and a power take-off side of the transmission, each disk pair including an axially fixed disk and an axially movable disk, wherein a disk pair is positioned on a respective shaft on the input side and on the take-off side,
an endless torque-transmitting means extending between the disk pairs for transmitting torque,
wherein at least one of the shafts includes at least one longitudinally-extending axial bore,
at least one first connecting bore that extends from the at least one axial bore to an outer surface of the shaft, the first connecting bore having an outlet at the shaft outer surface in a region that the movable disk overlies throughout its axial movement range,
an annulus defined between the shaft outer surface and a radially inner surface of the movable disk, which annulus can be subjected to hydraulic pressure through the at least one connecting bore, and
a discharge means for bleeding air bubbles from the annulus.

2. A belt-driven conical pulley transmission in accordance with claim 1, wherein the movable disk is connected to the shaft through axial teeth to provide a rotationally fixed and axially movable connection therebetween, and the axial teeth are positioned in the region of the annulus.

3. A belt-driven conical-pulley transmission in accordance with claim 2, wherein a first connecting bore outlet at the shaft outer surface is positioned in the region of the axial teeth, and the discharge means is defined by an axial groove that extends between the first connecting bore outlet and the annulus and has a bottom that is recessed relative to the shaft outer surface.

4. A belt-driven conical-pulley transmission in accordance with claim 3, wherein the axial teeth are positioned circumferentially outwardly of the axial groove and of the first connecting bore outlet.

5. A belt-driven conical-pulley transmission in accordance with claim 1, wherein the discharge means is defined by a discharge bore connected with and emerging from the annulus at an axial distance from the first connecting bore outlet and which communicates with a second axial bore.

6. A belt-driven conical-pulley transmission in accordance with claim 5, wherein an axial groove extends from the outlet of the discharge bore, and wherein the axial groove includes a bottom that is recessed relative to the shaft outer surface.

7. A belt-driven conical-pulley transmission in accordance with claim 1, wherein the annulus is sealed off on one side by a seal positioned between the shaft and an axial collar of the movable disk, and the discharge means is positioned to communicate with the annulus between the seal and the first connecting bore outlet.

8. A belt-driven conical-pulley transmission in accordance with claim 7, including a connecting channel that extends through the movable disk from a side of the annulus opposite to the seal into a pressure chamber for applying hydraulic pressure to axially shift the movable disk relative to the fixed disk.

9. A motor vehicle including a transmission comprising:
conical disk pairs on each of an input side and a power take-off side of the transmission, each disk pair including an axially fixed disk and an axially movable disk, wherein a disk pair is positioned on a respective shaft on the input side and on the take-off side,
an endless torque-transmitting means extending between the disk pairs for transmitting torque,
wherein at least one of the shafts includes at least one longitudinally-extending axial bore,
at least one first connecting bore that extends from the at least one axial bore to an outer surface of the shaft, the first connecting bore having an outlet at the shaft outer surface in a region that the movable disk overlies throughout its axial movement range,
an annulus defined between the shaft outer surface and a radially inner surface of the movable disk, which annulus can be subjected to hydraulic pressure through the at least one connecting bore, and
a discharge means for bleeding air bubbles from the annulus.
